(19) United States
(12) Patent Application Publication
(10) Pub. No.: US 2022/0008760 A1
(43) Pub. Date: Jan. 13, 2022

(54) SMART MASK WITH IOT FUNCTION

(71) Applicant: Tatung Technology Inc., Taipei City (TW)

(72) Inventors: Bing-Sheng CHEN, Taipei City (TW); Jo-Ying CHENG, Taipei City (TW)

(21) Appl. No.: 16/921,979

(22) Filed: Jul. 7, 2020

(51) Int. Cl. A62B 18/00; A62B 18/02; A62B 23/02; A41D 13/11

(52) U.S. Cl. CPC A62B 18/006; A41D 13/1184; A62B 23/025; A62B 18/02

(57) ABSTRACT

A smart mask with IoT function includes an airtight mask and an air filter device. The airtight mask has an inlet and an outlet. The air filter device has an input port and an output port connected respectively with the inlet and the outlet, and configured to provide clean air to the inlet. First, breathing data can be collected via the IoT function. Next, an algorithm can be implemented to allow the user to adjust the provision of the air to feel more comfortable during wearing the smart mask.

### BACKGROUND OF THE INVENTION

### 1. Field of the Invention

The present invention relates to the technical field of Internet of Things (IoT) and, more particularly, to a smart mask with IoT function.

### 2. Description of Related Art

A surgical mask or a medical mask is worn to cover the user's nose and mouth to prevent harmful substances from entering the user's nose and mouth or, on the other hand, to prevent the user's respiratory secretions or droplets from contaminating others or the environment.

However, the surgical mask or the medical mask can only block human's secretions or droplets, and has extremely limited ability to filter out harmful particles in the air, let alone harmful gases in the air.

Therefore, it is desirable to provide a novel mask to mitigate and/or obviate the aforementioned problems.

### SUMMARY OF THE INVENTION

One object of the present invention is to provide a smart mask that provides clean air to the wearer, and the smart mask has the function of Internet of Things, with which the operations of the smart mask can be controlled either automatically or manually. It can be understood that the purpose of IoT is to collect the data from the working data of the smart mask, such as CO₂ volume, air pressure, or air temperature. Because the smart mask is designed for people, it is important to collect all data relative to people's health in order to protect them. Any malfunction of the smart mask should be prevented, and any damage to people's heath should be avoided. For example, some people may wear masks when doing exercise, such as running or hiking. If they cannot get sufficient air pass through the masks, their lungs may get damaged. Therefore, the present invention aims to mitigate and/or obviate the aforementioned problems.

Another object of the present invention is to provide a portable mask that a commuter can wear during taking public transit, such as bus, subway, or railway, or during riding a bicycle or a motorcycle.

According to the present invention, there is provided a smart mask, which includes an airtight mask and an air filter device. The airtight mask has an inlet and an outlet. The air filter device has an input port and an output port connected respectively with the inlet and the outlet, and configured to provide clean air to the inlet.

Optionally or preferably, the airtight mask is transparent.

Optionally or preferably, the airtight mask is a half-cover type mask able to cover a user's mouth and nose, or an all-cover type mask able to cover not only the user's mouth and nose but also the user's eyes.

Optionally or preferably, the airtight mask is made of silica gel.

Optionally or preferably, the air filter device is a portable device.

Optionally or preferably, the air filter device further includes a pump configured to pump the clean air from the input port into the inlet.

Optionally or preferably, the pump has a motor capable of full speed operation up to 12 hours.

Optionally or preferably, the air filter device further includes an air entrance for external air to come into the air filter device, and an input filter connected between the air entrance and the pump.

Optionally or preferably, the air filter device further includes at least one filter slot to change the input filter.

Optionally or preferably, the input filter includes a surgical filter sheet having a waterproof layer and/or an antibacterial layer.

Optionally or preferably, the air filter device further includes an air exit for exhaled air to come out of the air filter device, and an output filter connected between the air exit and the output port.

Optionally or preferably, the output filter includes a desiccant.

Optionally or preferably, the output filter includes calcium chloride.

Optionally or preferably, the air filter device further includes a printed circuit board (PCB) configured to control the pump.

Optionally or preferably, the air filter device further includes a temperature sensor and/or a carbon dioxide sensor connected with the PCB.

Optionally or preferably, the PCB is configured to control the pump according to a sensing result from the temperature sensor and/or the carbon dioxide sensor.

Optionally or preferably, the PCB is configured to generate a displaying signal to represent using state(s) of an input filter and/or an output filter.

Optionally or preferably, the air filter device further includes a universal serial bus (USB) or a transceiver connected with the PCB.

Optionally or preferably, the USB includes a Type-C cable that allows voltage of 3V to 5V.

Optionally or preferably, the air filter device further includes a rechargeable battery connected with the pump.

Other objects, advantages, and novel features of the invention will become more apparent from the following detailed description when taken in conjunction with the accompanying drawings.

### BRIEF DESCRIPTION OF THE DRAWINGS

FIG. 1 is a schematically perspective view of the smart mask according to one embodiment of the present invention;

FIG. 2 is a schematic view of the smart mask worn on a user; and

FIG. 3 is a schematically perspective view of the smart mask according to another embodiment of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter; similarly, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, each component may be realized as a single circuit or an integrated circuit in suitable ways, and may include one or more active elements, such as transistors or logic gates, or one or more passive elements, such as resistors, capacitors, or inductors, but not limited thereto. Each component may be connected to each other in suitable ways, for example, by using one or more traces to form series connection or parallel connection, especially to satisfy the requirements of input terminal and output terminal. Furthermore, each component may allow transmitting or receiving input signals or output signals in sequence or in parallel. The aforementioned configurations may be realized depending on practical applications.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements, such as resistors, capacitors, or inductors may exist between the two elements. The electrical connection is used to send one or more signals, such as DC or AC currents or voltages, depending on practical applications.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

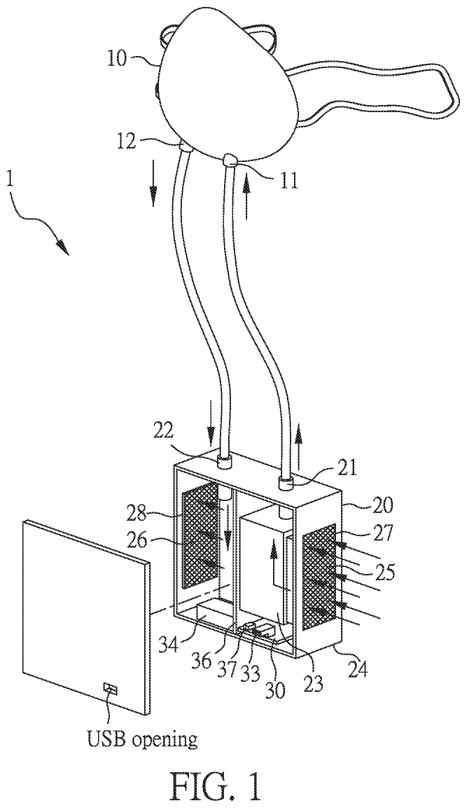

FIG. 1 is a schematically perspective view of the smart mask 1 according to one embodiment of the present invention.

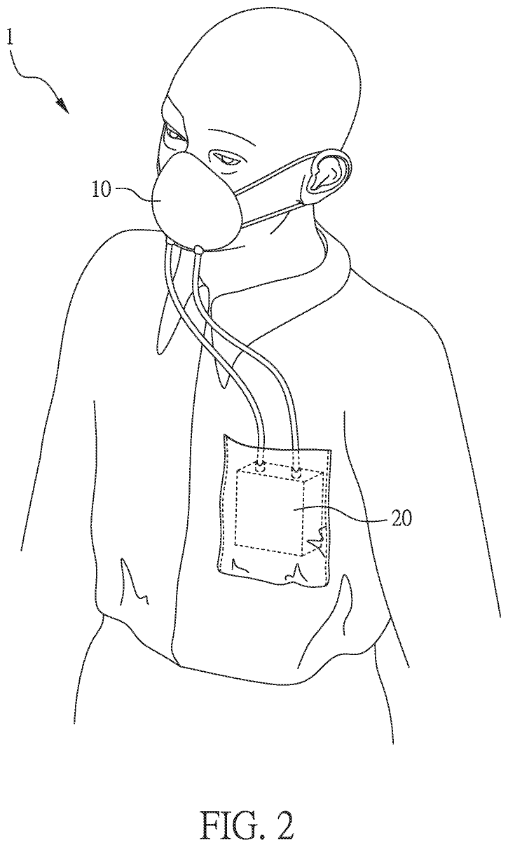

FIG. 2 is a schematic view of the smart mask 1 worn on a user.

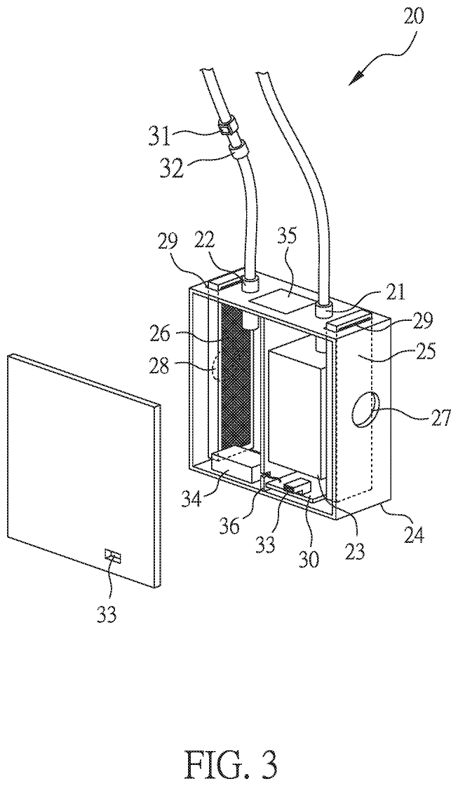

FIG. 3 is a schematically perspective view of the smart mask 1 according to another embodiment of the present invention.

The following description is made with reference to FIGS. 1 to 3 together.

As shown in FIG. 1, the smart mask 1 of the present invention mainly includes an airtight mask 10 and an air filter device 20. The airtight mask 10 has an inlet 11 which clean air comes into and an outlet 12 which exhaled air comes out of.

In one embodiment, the airtight mask 10 may be a half-cover type mask able to cover a user's mouth and nose, as shown in FIG. 2. In another embodiment, the airtight mask 10 may be an all-cover type mask able to cover not only the user's mouth and nose but also the user's eyes and, in this case, the airtight mask 10 may be transparent so that the user can remain his/her eyesight.

It is noted that the airtight mask 10 is designed to be isolated from the environmental air, and the air is provided into the airtight mask by the air filter device 20. In order to realize the airtightness of the airtight mask 10, the airtight mask 10 may be made of silica gel, which is flexible to fit with the user's face shape, and therefore less air leaks exist between the airtight mask 10 and the user's face. In addition, the silica gel is soft and comfortable to the user's face.

Correspondingly, the air filter device 20 has an input port 21 and an output port 22 connected respectively with the inlet 11 and the outlet 12 of the airtight mask 10, and configured to provide the clean air to the inlet 11 of airtight mask 10. The connections may be realized by flexible tubes made of plastic or silica gel, but not limited thereto.

The air filter device 20 is preferably a portable device having a size that can be put into the user's clothing pocket or bag, as shown in FIG. 2. In some embodiment not shown in the drawings, the air filter device 20 may be wore on the user's neck, or attached on the user's bag.

To discuss about the structure of the air filter device 20, the air filter device 20 may include a pump 23, a shell 24, an input filter 25, an output filter 26, and a printed circuit board (PCB) 30.

The shell 24 may be divided into an input room and an output room by an isolating component 36, such as a partition plate.

In addition to the input port 21 and the output port 22, there are still an air entrance 27 and an air exit 28 formed on the shell 24. The air entrance 27 is used for external air to come into the air filter device 20. The air exit 28 is used for the exhaled air to come out of the air filter device 20.

The pump 23 is configured to pump the clean air from the input port 21 into the inlet 11. Preferably, the pump 23 has a motor capable of full speed operation up to 12 hours.

The pump 23's speed may be adjustable. The user can set the pump 23's speed to get comfortable airflow. Because the user may walk fast or may be running, the pump 23's speed should be adjusted to keep the user feeling comfortable. When the output air pressure (or airflow) at the output port 22 is detected to be increasing, it probably means that the user is breathing heavily, and the pump 23's speed should accordingly be increased. The idea is to keep balance between the input air pressure and the output air pressure. The air may be increased according to an algorithm. However, the increased pump 23's speed should be limited to avoid any damage to the user's lung.

The input filter 25 is connected between the air entrance 27 and the pump 23, as shown in FIG. 3. Or alternatively, the input filter 25 may be arranged exactly on the entrance 27, as shown in FIG. 1. The input filter 25 may include at least one surgical filter sheet having a waterproof layer and/or an antibacterial layer. The input filter 25 may include a plurality of filtering layers (or sheets).

In one embodiment, the air filter device 20 may further include at least one filter slot 29 for changing the input filter 25, as shown in FIG. 3. In particular, when the input filter 25 includes surgical filter sheet(s), the user may remove one of old sheets and place a new sheet through the filter slot 29. The filter slot 29 may be designed to have a cover or a fixing mean.

The output filter 26 is connected between the air exit 28 and the output port 22, as shown in FIG. 3. Or alternatively, the output filter 26 may be arranged exactly on the exit 28, as shown in FIG. 1. The output filter 26 is mainly used to filter the exhaled air from the user. The exhaled air usually contains water steam, so the output filter 26 may include a desiccant, such as calcium chloride (CaCl₂) to process the water steam, but not limited thereto. However, in other embodiments, the output filter 26 may have structure(s) or material(s) similar to the input filter 25.

The PCB 30 is connected with the pump 23 and configured to control the pump 23. The PCB 30 has a processor to perform the control.

Optionally, the air filter device 20 may further include a temperature sensor 31 and/or a carbon dioxide (CO₂) sensor 32 connected with the PCB 30. Other types of sensors may of course be introduced into the present invention. The temperature sensor 31 or the carbon dioxide sensor 32 may be arranged to detect the temperature or the CO₂ concentration from the user's breathe. The PCB 30 may be configured to control the pump 23 according to a sensing result from the temperature sensor 31 and/or the carbon dioxide sensor 32.

For example, when the sensing result shows that the user's breathe temperature or CO₂ concentration is high, it possibly means that the user is exercising and needs more air, and then the PCB 30 can accelerate the pump 23's pumping speed (e.g. by increasing its pumping frequency) so as to provide more air to the airtight mask 10 for the user.

Preferably, the air filter device 20 may further include a universal serial bus (USB) 33 connected with the PCB 30. The USB 33 may be used for power supply. The smart mask 1 may be connected, via the USB 33, with an external computational device (not shown), such as smart phone, a personal computer, or a flat panel, that is installed with a mobile application (APP). The USB 33 may also be connected with a transceiver (for 3G, 4G, 5G, Wi-Fi, Bluetooth communications, etc.) to transmit data collected from the sensors, and/or receive instructions from the external computational device. In practices, the USB 33 may include a Type-C cable that allows voltage of 3V to 5V. The battery power level or the motor speed may also be controlled by the APP via the USB 33. The function of Internet of Things is therefore realized. In other embodiments, the USB 33 may be replaced by other types of connectors that can also realize the function of Internet of Things.

Alternatively, a transceiver 37 may be mounted in the air filter device 20 to serve as IoT equipment, which may be linked to an IoT hub, and all data may be collected and sent to a mobile or a personal computer (PC) through the IoT hub.

The user's breathe frequency may be detected by the temperature sensor 31, the carbon dioxide sensor 32, and/or a pressure sensor. In this way, for example, an institution (e.g. a hospital) may implement an APP to monitor the conditions of the user (e.g. a patient) who is going out to watch out the user's safety. The pump 23's speed may be adjusted according to the detected breathe frequency.

The air filter device 20 may use a rechargeable battery 34, such as a lithium battery connected with the electronic devices in the air filter device 20, for example, the pump 23, the PCB 30, and the sensors (if any). Other types of rechargeable batteries are also possible. The rechargeable battery 34 may be charged via the USB 33 when the USB 33 is connected with a power supply or an external computational device. In addition, as shown in FIG. 1, the rechargeable battery 34 may be arranged near the exit 28 so that it can be cooled down by the exhaled air incidentally.

Besides, the PCB 30 may be configured to generate a displaying signal to represent using state(s) of an input filter 25 and/or an output filter 26, for example, to show their pollution levels and whether they should be changed or cleaned. The displaying signal may also include information about battery power level, motor speed, sensor data, USB connection, and so on. In one embodiment, the displaying signal may be sent to and displayed on the external computational device. In another embodiment, the air filter device 20 may include a display panel 35 arranged on its shell 24 to directly display the information from the displaying signal. The display panel 35 may be a touch panel.

Anyway, the air filter device 20 may include some buttons on its shell 24 to control respective functions of respective components therein.

Although the present invention has been explained in relation to its preferred embodiment, it is to be understood that many other possible modifications and variations can be made without departing from the spirit and scope of the invention as hereinafter claimed.

What is claimed is:

1. A smart mask, comprising:
an airtight mask with an inlet and an outlet; and
an air filter device with an input port and an output port connected respectively with the inlet and the outlet, and configured to provide clean air to the inlet.

2. The smart mask of claim 1, wherein the airtight mask is transparent.

3. The smart mask of claim 2, wherein the airtight mask is a half-cover type mask able to cover a user's mouth and nose, or an all-cover type mask able to cover not only the user's mouth and nose but also the user's eyes.

4. The smart mask of claim 1, wherein the airtight mask is made of silica gel.

5. The smart mask of claim 1, wherein the air filter device is a portable device.

6. The smart mask of claim 1, wherein the air filter device further includes a pump configured to pump the clean air from the input port into the inlet.

7. The smart mask of claim 6, wherein the pump has a motor capable of full speed operation up to 12 hours.

8. The smart mask of claim 6, wherein the air filter device further includes an air entrance for external air to come into the air filter device, and an input filter connected between the air entrance and the pump.

9. The smart mask of claim 8, wherein the air filter device further includes at least one filter slot to change the input filter.

10. The smart mask of claim 8, wherein the input filter includes a surgical filter sheet having a waterproof layer and/or an antibacterial layer.

11. The smart mask of claim 6, wherein the air filter device further includes an air exit for exhaled air to come out of the air filter device, and an output filter connected between the air exit and the output port.

12. The smart mask of claim 11, wherein the output filter includes a desiccant.

13. The smart mask of claim 11, wherein the output filter includes calcium chloride.

14. The smart mask of claim 6, wherein the air filter device further includes a printed circuit board (PCB) configured to control the pump.

15. The smart mask of claim 14, wherein the air filter device further includes a temperature sensor and/or a carbon dioxide sensor connected with the PCB.

16. The smart mask of claim 15, wherein the PCB is configured to control the pump according to a sensing result from the temperature sensor and/or the carbon dioxide sensor.

17. The smart mask of claim 14, wherein the PCB is configured to generate a displaying signal to represent using state(s) of an input filter and/or an output filter.

18. The smart mask of claim 14, wherein the air filter device further includes a universal serial bus (USB) or a transceiver connected with the PCB.

19. The smart mask of claim 14, wherein the USB includes a Type-C cable that allows voltage of 3V to 5V.

20. The smart mask of claim 6, wherein the air filter device further includes a rechargeable battery connected with the pump.
